(19) United States
(12) Patent Application Publication
(10) Pub. No.: US 2004/0014486 A1
(43) Pub. Date: Jan. 22, 2004

(54) Portable communication apparatus and methods for match-making with distributed memory

(76) Inventors: Stephen J. Carlton, Raleigh, NC (US); Olle Bliding, Haverdal (SE); Jonas Runesson, Halmstad (SE); Anna Emanuelsson, Halmstad (SE); Lars Knutsson, Halmstad (SE)

Correspondence Address: Finnegan, Henderson, Farabow,, Garrett & Dunner, L.L.P., 1300 I Street, N.W., Washington, DC, 20005-3315, US

(21) Appl. No.: 10/418,086

(22) Filed: Apr. 18, 2003

Related U.S. Application Data
(60) Provisional application No. 60/373,660, filed on Apr. 19, 2002.

(51) Int. Cl. H04M 1/00

(52) U.S. Cl. 455/550.1; 455/567

(57) ABSTRACT

A portable communication apparatus for match-making with a plurality of remote communication apparatuses has memory means adapted to store match-making data, including local match-making data associated with the portable communication apparatus. A transceiver is adapted for wireless communication with a first remote communication apparatus, so as to transmit the local match-making data to the first remote communication apparatus, as well as to receive first remote match-making data associated with the first remote communication apparatus. A processing device is adapted to perform a correlation analysis between the local match-making data and the first remote match-making data and—in case a result of the correlation analysis indicates a match between the portable communication apparatus and the first remote communication apparatus—provide an alert to a user of the portable communication apparatus. The memory means is adapted to store the first remote match-making data, and the transceiver is adapted to transmit the first remote match-making data, in addition to the local match-making data, to a second remote communication apparatus.

### CROSS-REFERENCE TO RELATED APPLICATIONS

This application is related to and claims the benefit of priority under 35 U.S.C. §119(e) to U.S. Provisional Patent Application No. 60/373,660, entitled “A Portable Communication Apparatus and Methods for Match-Making With Distributed Memory,” filed Apr. 19, 2002, the disclosure of which is expressly incorporated herein by reference to its entirety.

### BACKGROUND OF THE INVENTION

I. Field of the Invention

Generally speaking, the present invention relates to electronic match-making. More specifically, the present invention concerns a portable communication apparatus and methods for match-making with a plurality of remote communication apparatuses.

II. Background Information

In general, match-making refers to a procedure of determining whether the properties of two objects have a degree of correspondence which is sufficient to qualify as a match between the two objects. One area where match-making is applicable is dating, i.e. the process of pairing together two persons, both of which seek friendship, partnership, a business relation, etc. To this end, match-making information will be exchanged between the two persons, they will both perform a correlation analysis between their own information and the received information, and then usually they will have a feeling whether there is a match between them or not. Depending on the dating situation the exchange of information will be performed in different ways. For example, a traditional approach is when one of the persons inserts a personal advertisement in a newspaper or on the internet, and the other person replies to it. The exchange of information is then usually made by writing letters or e-mails. Another example is the situation where the two persons meet in a coffee shop or a nightclub. The exchange of information is then simply made by talking.

A problem with the above dating methods, and conventional dating in general, is the considerable risk that two partly randomly chosen persons will not match. Not seldom, it takes considerable time before two persons realize that they do not match. If the dates are not supposed to be like quizzes, it will take time for two persons to know enough about each other to tell a match from a mismatch. Therefore, finding the right partner can be very difficult and also very time consuming, since one probably will have to date a number of different persons before one finds the ideal partner.

From U.S. Pat. Nos. 4,348,740, 4,348,744 to White, a method and an apparatus for comparison of sets of personal data are known. Users can enter data about themselves in these portable apparatuses and then compare their data by physically interconnecting the apparatuses by means of electrical connectors. Scores representing the compatibilities between users are shown on the apparatuses.

From German patent application DE 197 35 045 an information handling unit for comparing personality profiles is known. Like in the White invention above, users physically interconnect their apparatuses to compare stored data. Two interconnected units signal if there is a match between their users.

These known apparatuses have major disadvantages, one of which is that users have to carry their apparatuses in full view to be able to find each other, meaning that everybody else can see who is carrying such an apparatus. Another disadvantage is that users have to be very active and search for other users, because of the restricted operational range which is due to the physical interconnection technique. Additionally, when two users have seen each other, if they find each other interesting, they will have to make eye-to-eye contact in order to be able to compare their information, an indiscrete situation which in many ways can be very uncomfortable.

An improved apparatus is known from U.S. Pat. No. 6,150,937 to Rackman, disclosing a personal contact “Ice Breaker” badge which operates wirelessly by means of radio frequency (RF) communication. One type of contact badges are distributed to the boys in a group and another type to the girls in the group. All badges are provided with a light that can blink, and opposite badges in proximity with each other transmit and receive RF contact signals. If the lights on two badges blink at the same time, the carriers of the badges should start talking to each other. Whether this happens or not is based at least partly on probability, and the blinking is therefore no precise indication of a match between the carriers.

A somewhat similar apparatus and method for finding a date/mate is known from U.S. Pat. No. 6,020,810 to Har-Even. A user enters personal data into his/her apparatus. The data is transmitted to, and other data is received from, another apparatus by way of RF communication. The received and the transmitted data are compared, and a percentage match between them is determined. An alarm is activated if the percentage match is greater than a predetermined value.

From German patent DE 44 18 234 a unit similar to the Har-Even apparatus is known. Data entered by a user is transmitted to, and other data is received from, another unit through RF communication. If there is a mutual match between two units, their users will be alerted.

The present inventors have observed the following remaining problems with the prior art apparatuses briefly described above.

A first problem is that the user of a match-making apparatus is generally of the opinion that the more correlations that are carried out, the bigger are his or her chances of a good match. In portable match-making apparatuses known from the prior art, it has been suggested that radio signals can be used to transmit the match-making data. The use of radio signals is regrettably associated with the great disadvantage that the output power of the weak built-in radio transmitter limits the match-making to the nearby vicinity of the device. The obvious solution to this problem would be to increase the output power of the radio transmitter, but this would require more powerful batteries and most likely contribute not only to an increased weight of the match-making apparatus but also to a raised cost of such an apparatus, thus rendering the apparatus expensive and bulky.

A second considerable disadvantage with the match-making apparatuses known in prior art is that the match-making is geographically limited to the locations frequented by the carrier of the match-making apparatus. A person with static behavior, who for some reason only frequents a few areas (such as the office, the car and the apartment) where the number of users of match-making apparatuses is low and where new users almost never arrive, would not find much use of a match-making apparatus. Within a short time, he would have made correlations with everyone within the range of his apparatus. Prior art apparatuses would require this person to change his habits and start frequenting new areas, something that the person for some reason could be reluctant to do.

Yet a third problem with the prior art is that there is no way for a first person, being the user of a match-making apparatus, to know if a second person (the mailman, a friend, a business partner or any other acquaintance) who also carries a match-making apparatus frequents areas where the first person would have a good chance of finding a match, without following the second person wherever he or she might go. This would of course require not only that the second person would allow such a tailing to take place, but also that the first person would be allowed to enter zones imposing access limitations. Military installations, research facilities, conferences, work places, nightclubs, restaurants, gyms, airplanes, and locations which are not adapted to accommodate persons suffering from various kinds of disablements, are all examples of zones which may apply such access restrictions. A solution to this problem would be to attribute the second person with the first person's match-making apparatus. This solution would suffer from two drawbacks. Firstly, the first person would find himself without a match-making apparatus for some time, during which he/she otherwise could make a successful match should he/she carry the apparatus. Secondly, this approach would require the purchase of several match-making apparatuses, some of which would be intended to be carried by other persons. Not only would this be costly, but also require the first person to request other persons to carry an apparatus, which could be embarrassing for someone not wanting others to know about the use of such an apparatus. Furthermore, such use would rely on the good will of the other persons and compromise the integrity of the user information.

### SUMMARY OF THE INVENTION

In view of the above, the invention seeks to provide a solution or at least an improvement to the problems discussed above.

Generally, the above objectives are achieved by an apparatus and methods according to the attached independent patent claims.

One aspect of the invention is a portable communication apparatus for match-making with a plurality of remote communication apparatuses, said portable communication apparatus comprising:

memory means, wherein said memory means is adapted to store match-making data, including local match-making data associated with said portable communication apparatus;

a transceiver, wherein said transceiver is adapted for wireless communication with a first remote communication apparatus, so as to transmit said local match-making data to said first remote communication apparatus, as well as to receive first remote match-making data associated with said first remote communication apparatus;

a processing device, wherein said processing device is adapted to perform a correlation analysis between said local match-making data and said first remote match-making data and—in case a result of said correlation analysis indicates a match between said portable communication apparatus and said first remote communication apparatus—provide an alert to a user of said portable communication apparatus;

wherein said memory means is adapted to store said first remote match-making data; and

wherein said transceiver is adapted to transmit said first remote match-making data, in addition to said local match-making data, to a second remote communication apparatus.

Storing of not only the local match-making data but also the received first remote match-making data enables later transmission of the first remote match-making data, together with the local match-making data, to another apparatus, i.e. the second remote communication apparatus, without requiring any direct communication between the first and second remote communication apparatuses. Thus, even if these remote apparatuses are not within direct operating range of each other, their match-making data will nevertheless be cross-distributed thanks to the relaying action performed by the intermediate portable communication apparatus. This drastically increases the virtual operating range of the plurality of communication apparatuses with sustained transceiver output power. It also improves the opportunities for a successful match, since more apparatuses will be able to exchange match-making data and perform correlation analysis thereupon.

Advantageously, said transceiver is adapted to receive also third remote match-making data associated with a third remote communication apparatus from said first remote communication apparatus; and said processing device is adapted to perform a correlation analysis between said local match-making data and said third remote match-making data and—in case a result of said correlation analysis indicates a match between said local match-making data and said third remote communication apparatus—provide an alert to said user of said portable communication apparatus.

The processing device may be adapted to first check whether correlation analysis has already been performed for said first and said third remote match-making data, respectively, and, if so, refrain from performing the correlation analysis for said first and said third remote match-making data, respectively.

The memory means may include volatile memory and non-volatile memory, wherein said first and said third remote match-making data are stored in said volatile memory upon reception from said first remote communication apparatus and are stored in said non-volatile memory at least either periodically or at power-off of said portable communication apparatus.

Moreover, the memory means may further be adapted to discard said first and said third remote match-making data, once said processing device has indicated a match.

The memory means may also be adapted to store a predetermined maximum amount of remote match-making data on a first-in first-out basis.

The first and third remote match-making data may each include travel information pertaining to a number of steps of transmission between individual ones of said plurality of remote communication apparatuses from an original remote communication apparatus to said first and third remote communication apparatus, respectively, wherein said memory means is adapted to store said first and said third remote match-making data, respectively, only if its travel information is less than a predetermined limit.

Alternatively, the first and third remote match-making data may each include a time stamp, expressed in a common time base and indicating a time of origin, wherein said memory means is adapted to store said first and said third remote match-making data, respectively, only if its time stamp indicates an age which is below a predetermined limit.

The first or third remote match-making data may include contact information enabling said user of said portable communication apparatus to contact a user of said first or third remote communication apparatus through communication means other than said portable communication apparatus. The contact information may include an email address or a telephone number, or any other kind of information that indicates a manner, location or equipment, by means of which contact may be established.

Each of said match-making data may be associated with a respective apparatus-specific identity which is unique among said portable communication apparatus and each of said plurality of remote communication apparatuses.

The apparatus according to the invention may advantageously be embodied in or as a mobile terminal for a telecommunications network, or in or as a Portable Digital Assistant or a palmtop computer. Advantageously, such a mobile terminal comprises an operating system such as a Symbian operating system, and application software, the application software being adapted to be executed by the processing device and cause the processing device to perform aforesaid correlation analysis.

The transceiver may be adapted to communicate in accordance with the Bluetooth specification.

In one embodiment, the memory means is adapted to store prioritized match-making data of a limited number of users of remote communication apparatuses in non-volatile memory, wherein the transceiver is adapted to transmit all of this prioritized match-making data when communicating with a remote communication apparatus.

In one embodiment, the memory means comprises a predetermined number of memory blocks, each memory block being adapted to store remote match-making data that has traveled a respective number of steps of transmission between individual ones of the plurality of remote communication apparatuses from an original remote communication apparatus to the portable communication apparatus. The number of memory blocks may advantageously be 7.

One of these memory blocks may be adapted to store a larger amount of remote match-making data than another one of the memory blocks, said another one of said memory blocks being adapted to store remote match-making data having traveled more steps of transmission than remote match-making data that said one of said memory blocks is adapted to store.

Another aspect of the invention is a method for match-making between a portable communication apparatus and a plurality of remote communication apparatuses, comprising the steps of:

storing, in local memory in said portable communication apparatus, local match-making data associated with said portable communication apparatus;

establishing a first wireless link to a first remote communication apparatus; transmitting said local match-making data to said first remote communication apparatus;

receiving, from said first remote communication apparatus, first remote match-making data associated with said first remote communication apparatus;

performing a correlation analysis between said local match-making data and said first remote match-making data;

determining whether a result of said correlation analysis indicates a match between said portable communication apparatus and said first remote communication apparatus;

if so, providing an alert to a user of said portable communication apparatus;

storing said first remote match-making data in local memory in said portable communication apparatus;

establishing a second wireless link to a second remote communication apparatus; and

transmitting said first remote match-making data, in addition to said local match-making data, to said second remote communication apparatus.

The second aspect has essentially the same alternatives, features and advantages as the first aspect.

Yet another aspect of the invention is a method of exchanging match-making data between a portable communication apparatus and a remote communication apparatus over a wireless link. The method comprises the steps, performed in said portable communication apparatus, of

receiving a plurality of remote match-making data sets from said remote communication apparatus; and

deciding to store one of said plurality of remote match-making data sets depending on at least one of the following criteria:

i) an age or time of origin of said one data set;

ii) travel information pertaining to a number of steps of transmission for said one data set from an original remote communication apparatus to said remote communication apparatus;

iii) a fraction or an amount of remote match-making data sets that have already been stored prior to said one data set; and

iv) a random value.

Remote match-making data sets may be stored in said portable communication apparatus in local memory having a predetermined number of memory blocks, each memory block representing a number of steps of transmission for a data set from an original remote communication apparatus to said portable communication apparatus, wherein the decision to store said one of said plurality of remote match-making data sets may be limited to one of said memory blocks, which according to said travel information has a predetermined relation to said one data set.

The fraction or amount in criterion iii) may be a function of the intensity or frequency of prior data exchange between the portable communication apparatus and other remote communication apparatuses.

Other objectives, features and advantages of the present invention will appear from the following detailed disclosure, from the attached dependent claims as well as from the drawings.

### BRIEF DESCRIPTION OF THE DRAWINGS

Embodiments of the present invention will now be described in more detail, reference being made to the enclosed drawings, in which:

FIGS. 1a, 1b and 1c is a perspective view, a top view and a side view, respectively, of a portable communication apparatus according to one embodiment of the present invention;

FIG. 2a is a schematic illustration of an ideal use scenario, where a plurality of portable communication apparatuses are used for match-making between respective users and where most of the apparatuses are within direct operating range of each other;

FIGS. 2b-2f are schematic illustrations of practical use scenarios, where only some of the portable communication apparatuses are within direct operating range of each other but where, thanks to the invention, the actual operating range can be extended through a distributed memory functionality;

FIG. 3 is a schematic hardware block diagram for the apparatus shown in FIG. 1;

FIG. 4 is a schematic block diagram, which illustrates three major portions of the software in the apparatus shown in FIG. 1;

FIG. 5 is a flowchart diagram to illustrate a match-making method according to one embodiment;

FIG. 6 illustrates a data format for transmission of local match-making data from one of the apparatuses of FIGS. 2a-2f to another;

FIG. 7 illustrates a set of lists, which keep track of different apparatuses of FIGS. 2a-2f and are stored in different memories of the apparatus shown in FIG. 1;

FIG. 8 illustrates a data format for transmission, from one of the apparatuses of FIGS. 2a-2f to another, of local match-making data as well as remote match-making data, which has previously been received from other apparatuses of FIGS. 2a-2f;

FIG. 9 illustrates substitution of remote match-making data upon data exchange according to one embodiment; and

FIG. 10 illustrates a flow chart for the exchange of remote match-making data according to the embodiment of FIG. 9.

### DETAILED DISCLOSURE OF THE EMBODIMENTS

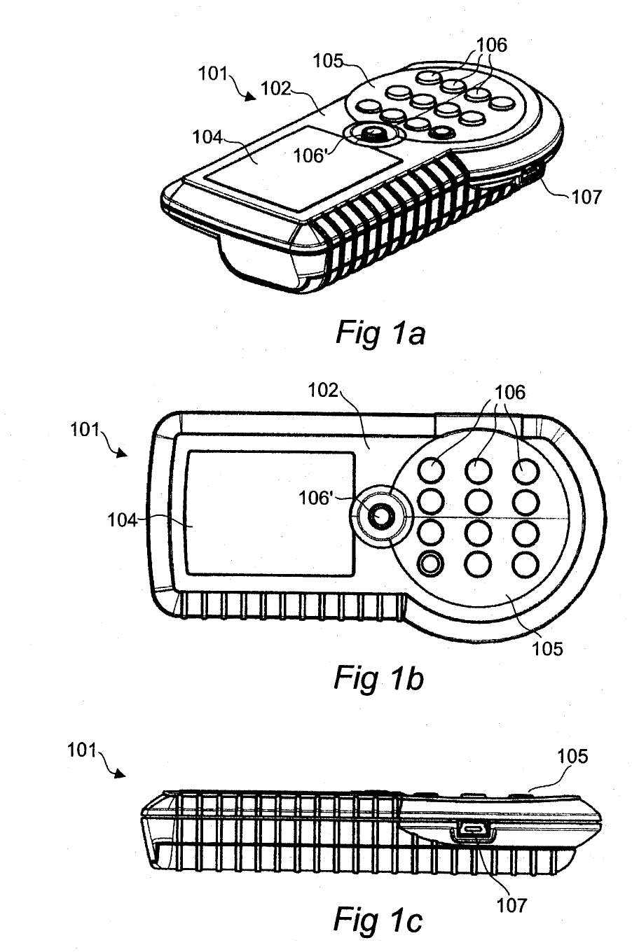

Initially, an overview of the functional features of the portable communication apparatus according to one embodiment of the present invention will be given with reference to FIGS. 1a-c and 2a-2f. Then, a detailed description of the structural features will follow with reference to the remaining figures.

FIGS. 1a-1c show a portable communication apparatus 101 according to one embodiment. The portable communication apparatus 101 is a wireless match-making device, assisting a user of the portable communication apparatus in meeting other people, each equipped with a respective portable communication apparatus of the same, or similar, type as apparatus 101.

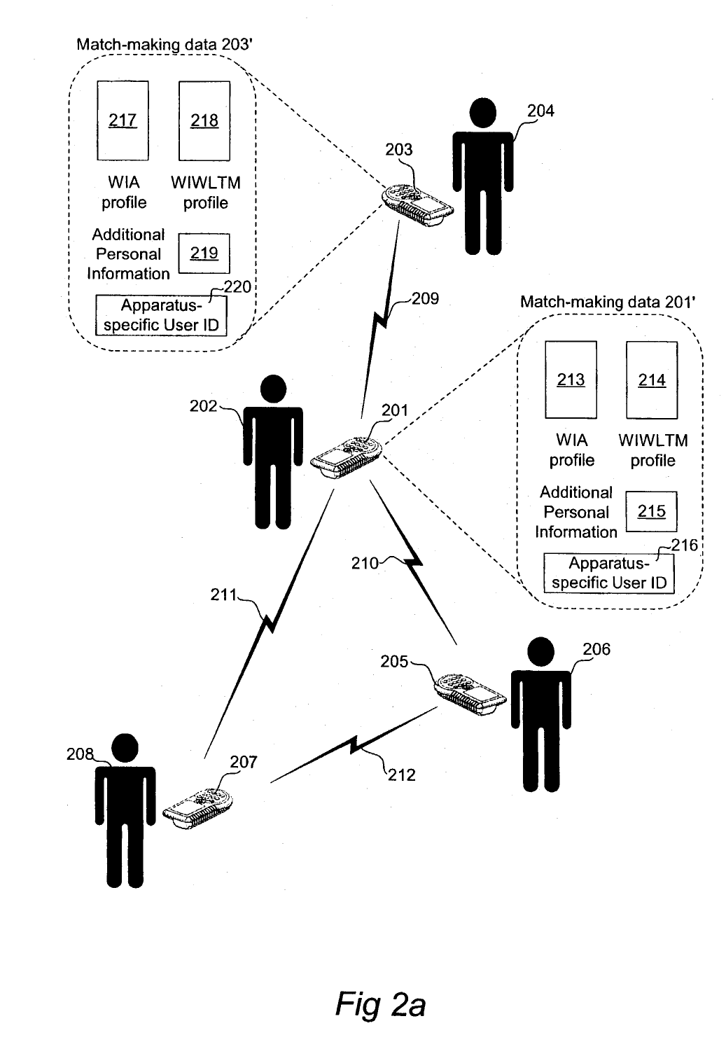

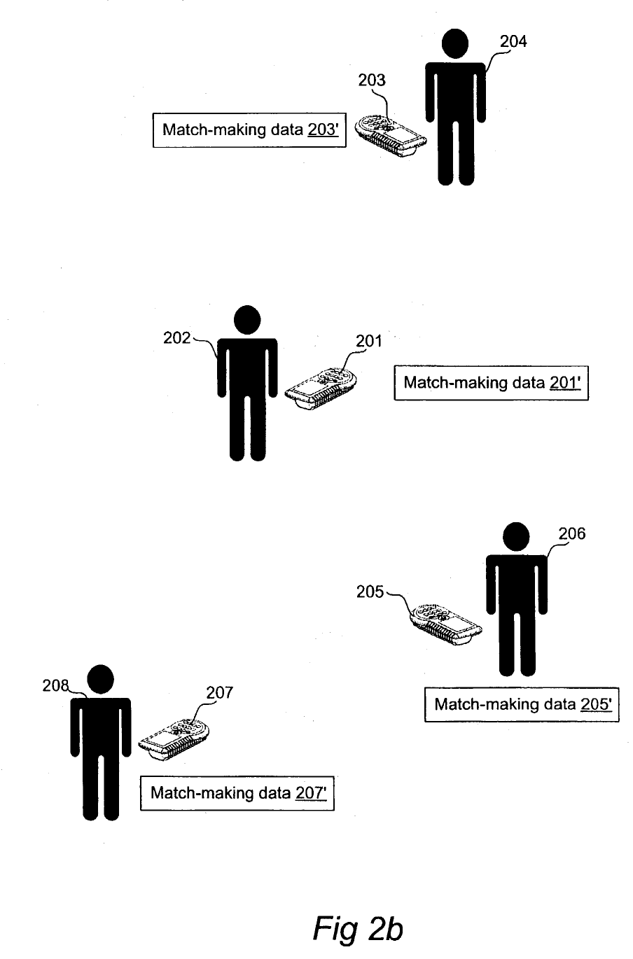

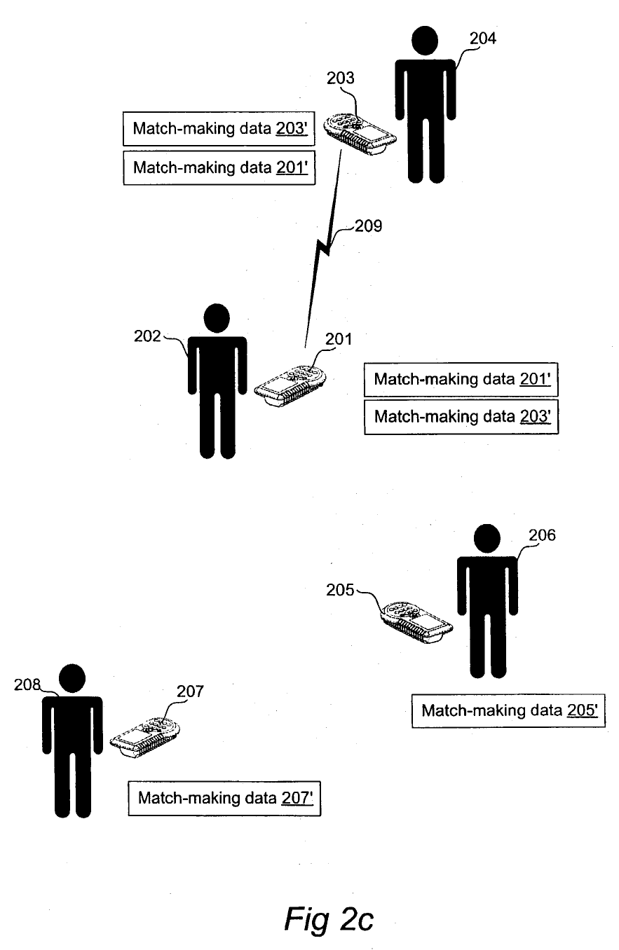

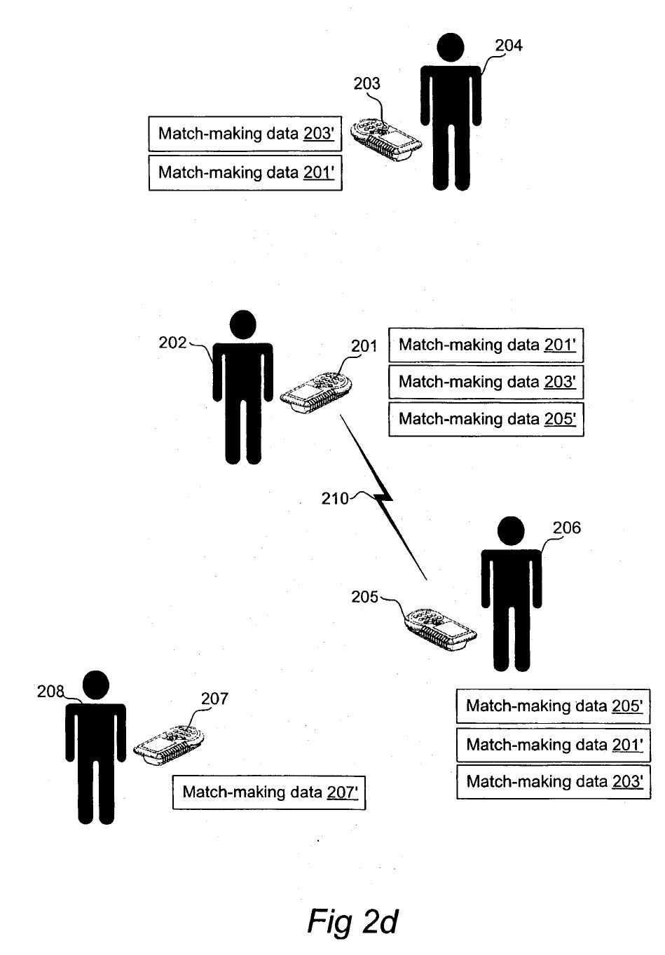

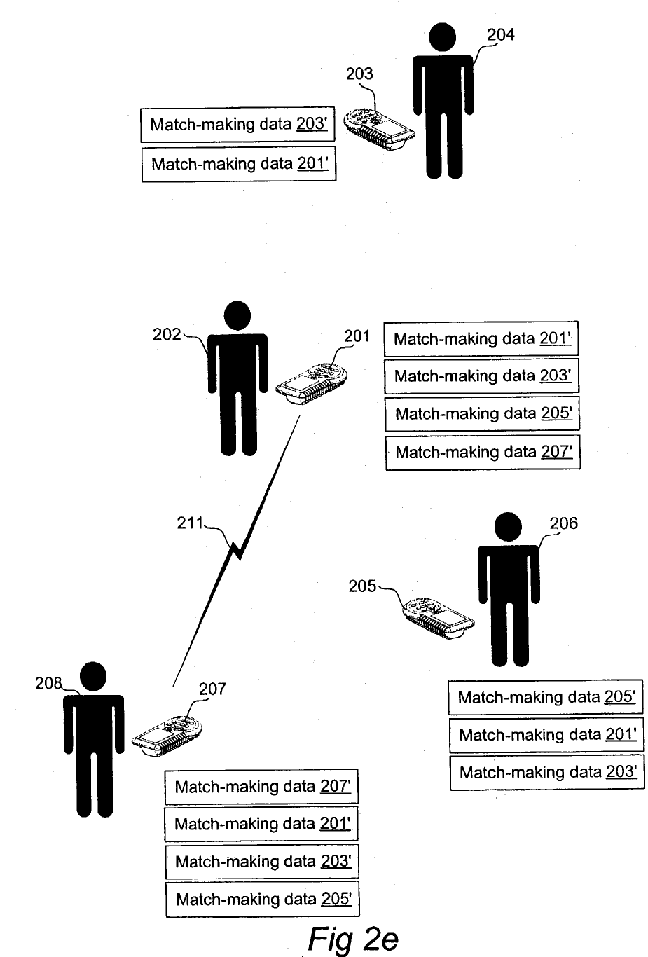

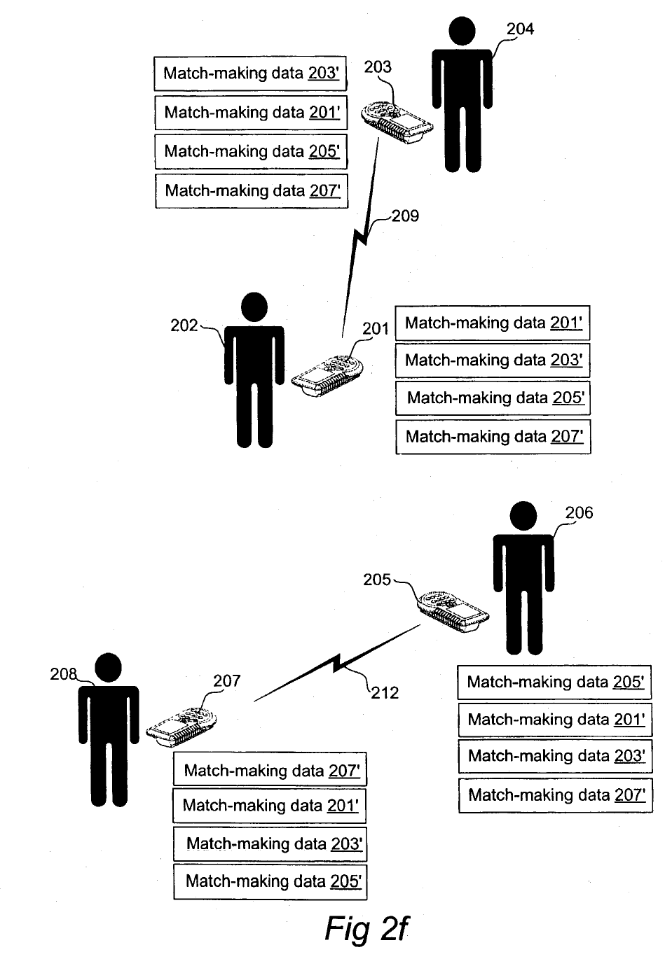

An ideal use scenario is illustrated in FIG. 2a. A plurality of users 202, 204, 206, 208 are provided with portable communication apparatuses 201, 203, 205, 207, each of which is essentially identical to the apparatus 101 of FIGS. 1a-1c. For reasons of simplicity, though, the apparatus 101 will be represented by the first apparatus 201 of FIGS. 2a-2f in the forthcoming discussions.

As will be described in more detail later, these multiple apparatuses 201, 203, 205, 207 will establish short-range wireless links 209, 210, 211, 212 between each other, exchange match-making data, perform a correlation analysis and alert the users when matches occur, all in an ad-hoc manner without the users' interaction, active involvement or knowledge. As seen in the ideal use scenario of FIG. 2a, most of the apparatuses are within direct operating range of each other.

Each user 202, 204, etc., will initially enter match-making data 201′, 203′, etc., about himself/herself. Thus, match-making data 201′ is associated with user 202 of apparatus 201 and is stored locally in this apparatus 201, whereas match-making data 203′ is associated with user 204 and is stored locally in apparatus 203, etc.

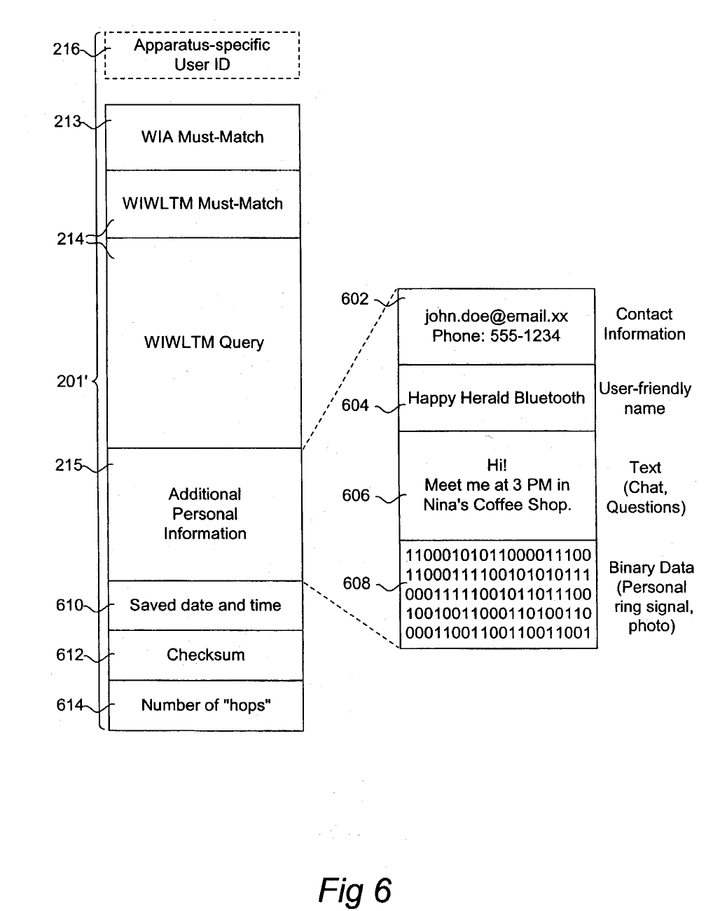

In operation, any of the apparatuses 201, 203, 205, 207, for instance apparatus 201, will then detect, without the knowledge of either the sending or receiving party, when other apparatuses 203, 205, 207 are within the same short-range area and, upon recognition, exchange match-making data with any and all of these other apparatuses across the wireless links 209, 210, 211, 212. As seen in FIG. 2a, the match-making data 201′ of user 201 may comprise a first profile 213, which pertains to the user himself/herself and is referred to as a “Who I am” (WIA) or “Me” profile, as well as a second profile 214, which pertains to a person that the user wishes to find and is referred to as a “Who I would like to meet” (WIWLTM) or “You” profile. The match-making data 201′ may also comprise additional personal information 215 and a unique apparatus-specific user-ID 216. As is illustrated in more detail in FIG. 6, the additional personal information 215 relates to personal particulars about the user, such as contact information 602 in the form of an email address, a mobile phone number, a university campus address, a school locker number, a hotel name and a room number, description of clothing, etc. The additional personal information 215 may also include a user-friendly name 604, a text message 606 and/or binary data 608 such as a personal ring signal, a photo, etc.

The match-making data 203′, 205′ and 207′ of users 204, 206, 208 of other portable communication apparatuses 203, 205, 207 will have a corresponding format.

On the receiving end, each apparatus will perform a correlation analysis between the incoming match-making data and the receiver's own match-making data. The sender's match-making data will be stored as remote match-making data in local memory in the receiving apparatus, and it may subsequently be retransmitted by the receiving apparatus, together with its own match-making data, to other apparatuses, as will be described in more detail later. In addition to the fields described above for local match-making data, such remote match-making data will contain information 610 about date and time of origin of the data, a checksum 612 and a counter 614 which represents travel information in the form of the number of “hops” or times that the match-making data has traveled since its original apparatus.

If the correlation analysis indicates a match between the local match-making data and any received match-making data in excess of a user pre-set matching alert level, the receiving apparatus will also alert its user of this exciting new match by visual, acoustical or tactile means.

In addition to the match-making described above, some embodiments of the portable communication apparatus 101 may optionally provide several other services, which are all based on the unique apparatus-specific user-ID 216, 220 of each apparatus 201, 203, 205, 207. Firstly, without going through a commercial mobile telecommunications network, a public service telephone network (PSTN) or a wide area network such as Internet, the users 202, 204, 206, 208 will be able to send and receive text messages, free of charge, between their apparatuses 201, 203, 205, 207. Once each apparatus-specific user-ID is known and any two apparatuses are within range of each other, the users of these apparatuses can perform encrypted instant text communication between each other—to some extent similar to commercial SMS, email and chat services.

This feature can also be used for asking and replying to questions in a broadcast manner. Again, without going through an existing commercial network and free of charge, users will be able to send any text-based question to all apparatuses which are presently in range or come into range. Apparatuses that receive these text-based questions can then respond to the sender, either via the contact information 602 included in the sender's additional personal information 215, 219 or, if still in range, directly via a text message reply 606 included in the additional personal information 215, 219 and addressed to the sender's apparatus-specific user-ID.

Pre-programmed with for instance a friend's or family member's unique user-ID, the portable communication apparatus 101 may (at the discretion of the user) actively search on its own for any and all other portable communication apparatuses and give an alert to the user, once the friend or family member is in range. This feature is particularly useful in large crowded places, where the presence of friends and loved ones may not be visually apparent. Of course, more than one apparatus-specific user-ID may be added to such a “Buddy Alert list”. In one embodiment, prioritized match-making data from a limited number of users, advantageously the ones on the Buddy Alert list, may be stored in non-volatile memory and always be exchanged together with the own (local) match-making data.

A similar optional feature is referred to as a “Blocked list”, which allows the user to pre-program a number of apparatus-specific user-ID's, for which communication is to be prohibited, in case they appear within range of the portable communication apparatus 101. Thus, thanks to this Blocked list, abusive or criminal individuals may be prevented from harassing the user of the portable communication apparatus 101, as regards match-making as well as follow-up services such as transmission of text messages or questions.

The particulars and advantages of the invention will become more evident with the help of FIGS. 2b-2f, which illustrate a chain of actions in a practical use scenario of the invention. In contrast to the ideal use scenario of FIG. 2a, in the practical and perhaps more realistic use scenario of FIGS. 2b-2f, only some of the portable communication apparatuses are within direct operating range of each other at any given time. Nevertheless, thanks to the invention, the virtual operating range can be extended by a distributed memory functionality, as will be apparent from the following disclosure. In addition, the invention will also assist in saving battery power, thanks to shorter communication ranges and fewer data transfers.

Typically, the wireless operating range of the apparatuses 201, 203, 205, 207 is only 10-100 m, and since the apparatuses are carried by mobile—typically walking—users, the number of other apparatuses 203, 205, 207 that are within range of a particular apparatus 201 will vary from time to time. Thus, the situations in FIGS. 2b-2f represent exemplifying and momentary views only.

FIG. 2b illustrates the situation at the beginning of the scenario. Four users 202, 204, 206, 208 have all acquired their own, personal match-making apparatuses 201, 203, 205, 207, respectively, and have provided their apparatuses with personal match-making data 201′, 203′, 205′, 207′, which has been stored in local memory in each respective apparatus. In more particular, as shown in FIG. 2b, match-making data 201′ associated with a first user 202 of a first portable communication apparatus 201 is stored locally in this apparatus, whereas match-making data 203′ associated with a second user 204 is stored locally in a second portable communication apparatus 203, match-making data 205′ associated with a third user 206 is stored locally in a third portable communication apparatus 205, and match-making data 207′ associated with a fourth user 208 is stored locally in a fourth portable communication apparatus 207.

In the disclosed embodiment, the match-making data of each user comprises a unique user ID, a “Who I am” (WIA) profile, a “Who I would like to meet” (WIWLTM) profile as well as additional personal information, as has been illustrated for apparatuses 201 and 203 in FIG. 2a.

Now, as seen in FIG. 2c, when the users 202 and 204 bring their apparatuses 201 and 203 within operating range of each other, a wireless link 209 is established between the apparatuses, followed by exchange of match-making data and correlation analysis of the received match-making data by each apparatus in an ad-hoc manner without the user's knowledge. These steps will be described in more detail later with reference to the remaining figures.

Assuming that their WIA and WIWLTM profiles differ too much, the correlation analyses performed in both apparatuses 201, 203 will not result in a match between users 202 and 204. In contrast to prior art apparatuses, where the received match-making data now would have been discarded, the received match-making data is instead stored in local memory in each apparatus 201, 203 so as to allow subsequent distribution to other apparatuses. In more detail, as indicated in FIG. 2c, the first apparatus 201 does no longer store only the match-making data 201′ which is associated with the first user 202 but also the match-making data 203′ which is associated with the second user 204 of the second apparatus 203. Correspondingly, the second apparatus 203 does no longer store only the match-making data 203′ which is associated with the second user 204 but also the match-making data 201′ which is associated with the first user 202 of the first apparatus 201.

The wireless link 209 between the apparatuses 201 and 203 is of temporary nature and will typically only be maintained for the duration of the data exchange. In any event, link 209 will cease to exist once the apparatuses 201 and 203 are no longer within direct operating range of each other, for instance because one user 202 has moved away from the other user 204.

Thus, in FIG. 2d, user 202 has moved his first apparatus 201 out of range of the second apparatus 203, but instead within operating range of the third match-making apparatus 205, which belongs to user 206. A wireless link 210 is established between the first and third apparatuses 201 and 205, followed by exchange of match-making data and correlation analysis of the received match-making data by each apparatus. This time, however, instead of only receiving the match-making data 201′ relating to user 202 of the first apparatus 201, the third apparatus will also receive the match-making data 203′ relating to the second user 204 and acquired during the previous communication between the first and second apparatuses 201, 203 in FIG. 2c. Thus, correlation analysis is performed by apparatus 205 not only on the match-making data 201′ but also on the match-making data 203′, and both sets of data will be stored in local memory in the third apparatus 205.

Correspondingly, the first apparatus 201 will receive the match-making data 205′ relating to user 206 of the third apparatus 205, perform the correlation analysis and store the match-making data 205′ in local memory.

In the disclosed example, regrettably, neither of the correlation analyses performed by the apparatuses 201 and 205 results in a matching alert between any of the first, second and third users 202, 204, 206.

Following the above, as illustrated in FIG. 2e, the third user 206 of the third apparatus 205 moves out of range of the first apparatus 201, but instead the fourth user 208 of apparatus 207 moves within operating range of apparatus 201. After having established a wireless link 211, the first apparatus 201 will receive the match-making data 207′ of user 208, upon which correlation analysis is subsequently applied, whereas the fourth apparatus 207 can benefit from acquiring no less than three sets of match-making data, 201′, 203′ and 205′, associated with users 202, 204 and 206.

Continuing with the example, it is assumed that the correlation analysis performed by the fourth apparatus 207 on the match-making data 203′ of the second user 204 results in a match between users 208 and 204. In this way, thanks to the invention, user 208 can become aware of the match with user 204 without direct communication and exchange of match-making data between apparatuses 207 and 203. Advantageously, the fourth user 208 will make use of the additional personal information 219 included in the match-making data 203′ of the second apparatus 203 so as to make contact with the second user 204 through an e-mail address, a telephone number, a predetermined meeting point, etc.

FIG. 2f illustrates a possible final scenario, where data exchange between on the one hand apparatuses 201 and 203, over a wireless link 209, and on the other hand apparatuses 205 and 207, over a wireless link 212, results in a situation where all apparatuses 201, 203, 205, 207 in addition to their own match-making data have obtained the match-making data of the other apparatuses and are prepared to distribute these sets of match-making data further to other remote apparatuses not shown in FIG. 2f.

In some embodiments of the invention, restrictions may be applied as regards the way in which every received set of match-making data is stored and distributed further. One option is the aforesaid “Blocked list”, which will be described more thoroughly later and which will allow an individual user to prevent data exchange with certain undesired users. Another option is to limit the distribution of received match-making data to a given group of users, such as friends or relatives, for instance the ones that are present in aforesaid “Buddy Alert list”.

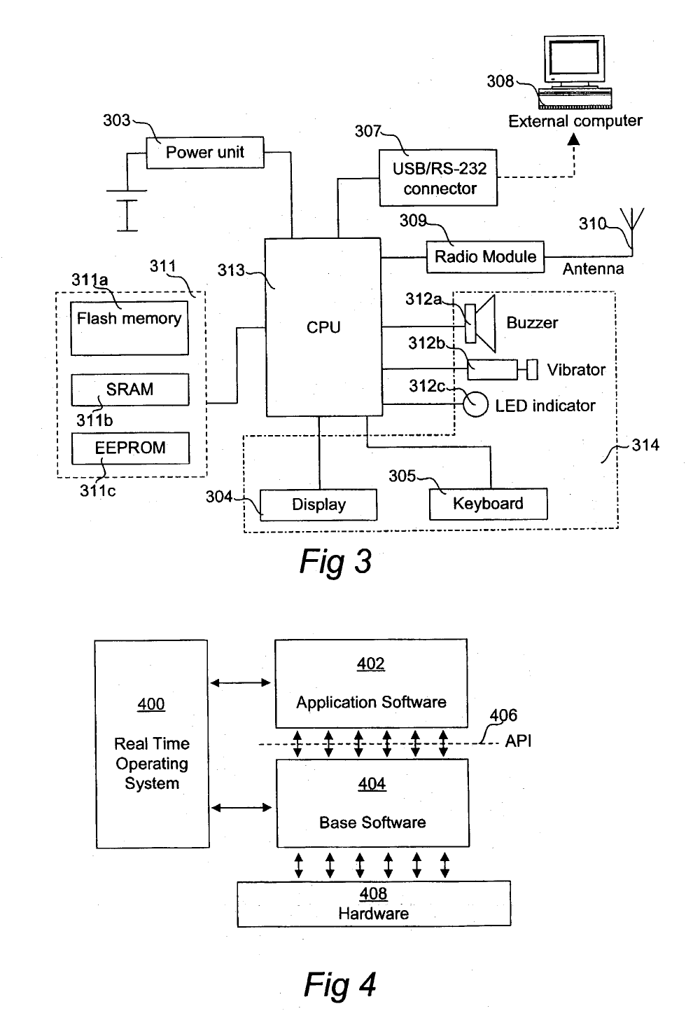

The particulars of the portable communication apparatus 101 will now be described with reference to FIGS. 1a-c, which show the externally visible components, as well as FIG. 3, which is a block diagram schematically illustrating the hardware components of the portable communication apparatus 101 and disclosing its internal structure.

The portable communication apparatus 101 comprises a casing 102, which is small enough for the portable communication apparatus to be held in one hand or carried in, for example, a pocket or a handbag. The casing can have a number of different designs when it comes to shape, colors etc., and it is preferably removable, thereby allowing a user to change the appearance of his/her portable communication apparatus by replacing the casing with another one. Advantageously, the casing has a design which resembles a contemporary, miniaturized mobile telephone, PDA (portable/pocket digital assistant), video game controller, etc. A power unit 303 accommodating four batteries, preferably rechargeable ones, is arranged inside the casing 102.

Furthermore, the apparatus 101 comprises a display 104, 304 for interaction with the user of the portable communication apparatus. In standby mode, the display may, for example, indicate the remaining power level for the power unit 303, the time and date, as well as various graphical elements such as icons, buttons and dialog boxes which are produced by the application software.

The portable communication apparatus also has a keyboard 105, 305, allowing the user to operate the portable communication apparatus 101 through a number of keys 106 and a joystick 106′. According to the preferred embodiment, the keyboard 105, 305 has a design in similar with a contemporary mobile phone, i.e. the keys 106 represent a number of symbols, such as digits and/or characters. In addition to the keyboard 105, 305, the portable communication apparatus 101 has a connector 107, 307 for connecting the portable communication apparatus to an external computer 308.

For wireless data exchange with any available portable communication apparatus, the portable communication apparatus 101 comprises a radio module 309. In the preferred embodiment the radio module 309 is a transceiver which is adapted for short-range radio communication in accordance with the Bluetooth™ specification in the 2.4 GHz ISM band (“Industrial, Scientific and Medical”). For details about the Bluetooth specification, reference is made to the Bluetooth Core Specification (also known as Bluetooth Specification, Volume I) and the Bluetooth Profiles Definition (also known as Bluetooth Specification, Volume II), both of which are available at <www.bluetooth.org>. The portable communication apparatus 101 also has an antenna 310 through which Bluetooth radio communication with the other portable communication apparatuses is performed. In the preferred embodiment the transceiver 309 and the antenna 310 have an operating range of about 10-100 m, although the range can vary due to environmental conditions, and the exact values are not critical to the invention.

In the preferred embodiment, the aforesaid unique apparatus-specific user-ID 216 of the portable communication apparatus 101/201 is formed by a 48-bit Bluetooth address (known as BD address in the Bluetooth specification), which is associated with the individual Bluetooth transceiver 309.

In alternative embodiments the transceiver can instead be adapted for another type of radio interface, or infrared communication (such as IrDA—“Infrared Data Association”), or essentially any other available standard for short-range communication between a hand-held apparatus and an external apparatus.

The portable communication apparatus 101 further comprises memory means 311 for storing various information in the portable communication apparatus 101, such as information needed for the function of the portable communication apparatus (e.g. program code and static data), information entered by the user of the portable communication apparatus (e.g. local match-making data), and information received from remote portable communication apparatuses (e.g. remote match-making data).

Additionally, for further interaction with the user, the portable communication apparatus 101 has alerting means such as a buzzer 312a for emitting ring tones, a vibrator 312b for a more discrete alerting and an LED 312c for emitting light. The display 304 and the keyboard 305 together with these alerting means jointly form a user interface 314.

Finally, a CPU 313 in the portable communication apparatus 101 controls the operations of the portable communication apparatus.

Before information is exchanged with another portable communication apparatus, the information is advantageously but not necessarily encrypted to increase the safety and privacy for users. Therefore, the portable communication apparatus 101 may comprise encryption and decryption means for encrypting information prior to transmission, and decrypting information after reception. The encryption means advantageously operates according to any data encryption algorithm known per se, such as an asymmetric algorithm like RSA, or a symmetric algorithm like DES. The decryption means will operate in accordance with the corresponding data decryption algorithm. Advantageously, the encryption and decryption means are implemented as software modules stored in the memory means 311 and executed by the CPU 313, or alternatively as hardware.

A selection of components will now be described in more detail for the embodiment illustrated in FIG. 3. It is to be understood, however, that this selection is in no way limiting to the invention; various other commercially available components may be chosen in place of the ones disclosed, as is readily realized by a skilled person. Moreover, a detailed description of hardware and software, by which a portable communication apparatus according to the invention may be implemented, is given in Applicant's U.S. patent application Ser. No. 10/125,461 as well as in Applicant's co-pending PCT application claiming priority thereof, the contents of which are incorporated herewith by reference.

The transceiver 309 is a BiCMOS class 1 Bluetooth radio module, which is of type PBA31302/1 and is available from Ericsson Microelectronics AB, Isafjordgatan 16, SE-164 81 Kista, Sweden. It provides fast frequency hopping, with 1600 channel hops per second, using 79 channels between 2.402 and 2.480 GHz, and allowing a maximum bit rate of 1 Mbit/s. The radio module has a 13 MHz reference frequency crystal, which is available from Taitien Electronics Co., Ltd, 5 Fl. 76, Po Ai Road, Taipei, Taiwan 100.

The selection of the antenna 310 will depend on the design of the casing 102 as well as its desired size, format and flexibility. In the preferred embodiment, an ICM antenna which fits to the inside of the casing is selected. The ICM antenna is available from gigaAnt, Ideon Science & Technology Park, Ole Römers väg 16, SE-223 70 Lund, Sweden. Alternatively, a Flavus/Crispus antenna from the same company may be used.

The CPU 313 is a Bluetooth baseband processor of type PBM99090/1, which is available from Ericsson Microelectronics AB. It uses a clock frequency derived from the radio clock signal and includes an ARM7 RISC (12-40 MHz), which provides adequate performance for the functionality of the apparatus 101. The baseband processor has a 64 KB internal RAM memory and handles communication protocols (Bluetooth embedded stack ver 1.00) as well as the higher-level functionality of the apparatus 101, as described throughout this document.

The memory means 311 associated with the CPU 313 consists of a 1 MB flash memory 311a, a 512 KB external static RAM (SRAM) memory 311b and a serial 32 KB EEPROM memory 311c, wherein the latter acts as a scratchpad memory for the functionality provided by the apparatus 101. The flash memory 311a is of type BGA48, which is available from Silicon Storage Technology, Inc., 1171 Sonora Court, Sunnyvale, Calif. 94086, USA, under article number SST39VF800A-70-4C-B3K. The SRAM memory 311b is of type BA48B and is available from Cypress Semiconductor Corporation, 3901 North First Street, San Jose, Calif. 95134, USA, under article number CY62147CV25LL70BAI. The EEPROM memory 311c is of type SOIC-8 and is available from Atmel Corporation, 2325 Orchard Parkway, San Jose, Calif. 95131, USA, under article number AT24C256 N-10SC-2.7.

The connector 307 provides a serial interface to the external computer 308 and comprises, in the preferred embodiment, an RS232 interface as well as a USB interface, both of which are supported by the baseband processor. USB provides the most user-friendly interface, is faster and has the cheapest hardware. It also makes it possible to power/charge the apparatus 101 while connected, as USB also provides power through its communication cable.

RS232, on the other hand, does not provide power. Thus, in that case charging has to be done through the power unit 303. The power unit 303 comprises four AAA battery cells connected in series with each other, and a step-down converter, which is of type MAX1724EZK27-T and is available from Maxim Integrated Products, Inc., 120 San Gabriel Drive, Sunnyvale, Calif. 94086, USA. The battery cells may be of rechargeable type and may receive charging power from either an internal or an external AC/DC converter. Some embodiments of the invention may use battery technologies known from the field of mobile telephones, such as Li ion, Li polymer, NiMH or NiCd batteries.

In alternative embodiments, the communication between the external computer 308 and the portable communication apparatus 101 may be performed wirelessly, i.e. the connector 307 is replaced by a wireless interface such as IrDA or, in fact, Bluetooth.

The display 304 is a 64×128 LCD module of type WD-G1206Y1WNNa, which is available from Wintek Corporation, 427 North Sixth Street, Lafayette, Ind. 47901-1126, USA.

The buzzer 312a is a MQT-03EX buzzer from Star Micronics Co., Ltd, 20-10, Nakayoshida, Shizuoka 422-8654, Japan.

The vibrator 312b and the LED indicator 312c may be selected from various appropriate available component manufacturers.

As seen in FIG. 4, the software of one embodiment of the portable communication apparatus 101 is divided into three major sub systems: an application software portion 402, a base software portion 404 and a Real Time Operating System 400. The operating system 400 is OSE, which supports multitasking and provides high real time performance. A predefined application programming interface (API) 406 is provided between the application software 402 and the base software 404. The application software includes various segments of program code, which when executed by the CPU 313 will implement all the necessary functionality of the portable communication apparatus 101. The base software provides supportive base functionality and hardware-dependent functionality to interact with the hardware 408 of the apparatus 101.

The application software 402 may generally operate in an event-driven manner upon user events generated by the base software 404, for instance keyboard events, Bluetooth events indicating actions from other portable communication apparatuses, serial communication events associated with the external computer 308, and system events such as power monitor events indicative of a battery status of the power unit 303.

The base software 404 provides various services to the application software, such as Bluetooth functionality, keyboard interface, display interface, non-volatile memory interface and serial communication interface.

The application software 402 will perform different tasks, such as management of match-making data (e.g. editing, storing and loading of local match-making data 201′), Bluetooth functionality (inquiring for available remote apparatuses 203, 205, 207, connecting to an individual remote apparatus and exhange of match-making data with this apparatus), and match-making procedure (analysis of the correlation between the received match-making data 203′/205′/207′ and the corresponding local match-making data 201′ stored in the apparatus 201 so as to investigate a potential match between the user 202 and a user 204/206/208 of any of the remote apparatuses 201/203/205). The application software 402 will also provide additional communication services, such as chat and ask-questions functionality.

The match-making procedure according to one embodiment will now be described further. As previously mentioned, the match-making data 201′, 203′, 205′, 207′ for each user 201, 203, 205, 207 of a respective apparatus 202, 204, 206, 208 will include a WIA (“Who I am”) profile, representing the user himself, as well as a WIWLTM (“Who I would like to meet”) profile concerning a person that the user wishes to find.

The description below pertains to an exemplifying embodiment only. A detailed description of match-making, including several alternatives of match-making (profile) data and correlation analysis performed thereupon, that may be used according to the present invention, is given in Applicant's U.S. patent application Ser. No. 10/125,404 as well as in Applicant's co-pending PCT application claiming priority thereof, the contents of which are incorporated herewith by reference.

Each profile may consist of a large number of parameters grouped into different categories. The layout (order) of the parameters will be fixed, and the layout definition (grouping, attribute texts, etc) will be saved in the flash memory 311a. The editable part (the actual parameter values as set by each user) of each profile will be permanently saved in the EEPROM memory 311c and copied into the SRAM memory 311b upon application initialization.

Each profile may include two categories of match-making parameters; Must-Match parameters and Query parameters. As the name implies, the Must-Match parameters are of crucial nature, in this exemplifying embodiment, and must be completely fulfilled for two persons, for there to be any chance at all for a match between them. The Query parameters are of “less importance”; they do not need to be completely fulfilled for two persons, but fulfilled up to a certain level, for a match. As an example, if a heterosexual man would like to meet a partner, the partner has to be a heterosexual or bisexual woman or there will be no match. Thus, “Gender” and “Sexual orientation” belong to the group of Must-Match parameters. However, if this man likes music and he would like to meet a partner who also likes music, there is a possibility for a match even with a partner who does not like music. Thus, “Listening to music” belongs to the group of Query parameters.

The Must-Match parameters may be stored in 4 bits and therefore hold a value from 0 to 15. The value represents a property which is specific for each Must-Match parameter. Some questions may have only a few properties (such as Gender), whereas other may have many properties. In the exemplifying but not limiting embodiment referred to above, the Must-Match parameters are: Gender, Sexual orientation, Age, Marital status, Education and Body type.

The Query parameters may be considerably more numerous than the Must-Match parameters. Each Query parameter may have a value from 0 to 2 (decimal form), representing the possible answers “Agree” (“Yes”), “Disagree” (“No”) and “Don't care” to a corresponding question associated with the respective Query parameter. More specifically, the possible answers are expressions stating how much a quality or an activity agrees with someone's personal interests. As an example, if the question concerns “Shopping” and the user loves shopping, the answer to the question in the user's WIA profile should, of course, be “Agree”. Moreover, if the user wants a partner who is also fond of shopping, the answer to the question in the user's WIWLTM profile should also be “Agree”. On the other hand, if the user does not care that much about the shopping interest of a potential partner, the answer to the question in the user's WIWLTM profile could instead be “Don't care”.

Other non-limiting examples of Query parameters are: Reading, Painting, Sewing, Watching TV, Aquariums, Surfing the Internet, Watching sports, Writing, and Gardening. Many more parameters are however possible.

Each user 202, 204, 206, 208 of a portable communication apparatus 201, 203, 205, 207 according to the present invention will personalize their WIA and WIWLTM profiles 213/217, 214/218 by inputting the information referred to above. In one embodiment, this is done by presenting aforesaid questions, one by one, on the display 104/304 and inviting the user to answer the questions by operating the keys 106 and the joystick 106′ on the keyboard 105/305. The additional personal information 215/219 will be completed in a corresponding manner. In an alternative embodiment, the user may instead view the questions on a CRT or LCD screen associated with the external computer 308 and complete the profiles 213/217, 214/218, as well as the additional personal information 215/219, by means of the computer keyboard. After completion, the information will be downloaded to the portable communication apparatus by means of the connector 107/307.

In the aforesaid embodiment, the entire WIWLTM profile 218 but only the Must-Match part of the WIA profile 217 are included in the match-making data which is actually exchanged between portable communication apparatuses 201, 203, 205, 207. FIG. 6 illustrates the match-making data 201′ which is transmitted from the first apparatus 201 to other apparatuses 203, 205, 207 in FIGS. 2a-2f. This disposition has an advantage in terms of personal integrity; the values of the numerous Query parameters are kept secret within each apparatus. However, it is to be understood that no details concerning the format, disposition or contents of the match-making profiles are central or critical aspects of the present invention.

The analysis of the correlation between the local match-making data 201′ stored in the apparatus 201 and each set of remote match-making data 203′, 205′, 207′ received from another apparatus 203, 205, 207 may be performed in the following way. In one embodiment, the analysis is divided into two steps, where the first step concerns the Must-Match parameters and the second step concerns the Query parameters but is only performed if the outcome of the Must-Match analysis is positive. More specifically, in the first step the Must-Match parameters of the WIA profile 213 included in the match-making data 201′ associated with the user 202 of the first (local) apparatus 201 are compared to the Must-Match parameters of the WIWLTM profile 218 included in the match-making data 203′ associated with the user 204 of the second (remote) apparatus 203, and the result of the comparison is a first value of correlation. The first value of correlation, which may be a number between 0 and 1, is a measure of how well the user 202 matches the desires of the user 204; a value of 1 indicates a complete match, whereas a value of 0 indicates no match at all. Then, in a corresponding manner, the Must-Match parameters of the WIWLTM profile 214 associated with the user 202 are compared to the Must-Match parameters of the WIA profile 217 associated with the user 204 of the remote apparatus 203, and the result of this comparison is a second value of correlation.

The first and the second value of correlation are then compared with a first and a second threshold value, respectively. If the first and second values of correlation meet or exceed the respective first and second threshold values, the users 202 and 204 match each other well enough regarding the Must-Match parameters, and the correlation analysis proceeds with the second step. On the other hand, if either of the first or the second value of correlation does not meet or exceed the first or second threshold value, respectively, then there is considered no match between the users 202 and 204, and the correlation analysis is terminated without performing the second step. In the aforesaid embodiment, the first and second threshold values are both equal to 1. Thus, the requirement for continuing with the second step of the correlation analysis, i.e. the step concerning the Query parameters, is that the users 202 and 204 match each other completely regarding the Must-Match parameters. The first and second steps of correlation analysis are performed in the corresponding manner in the remote apparatus 203.

In the second analysis step, the Query parameters of the WIA profile 213 associated with the first user 202 are compared to the Query parameters of the WIWLTM profile 218 associated with the second user 204. The result of the comparison is a third value of correlation between 0 and 1. The third value of correlation for the Query parameters corresponds to the first value of correlation for the Must-Match parameters. Thus, the third value of correlation is a final measure of how well the user 202 matches the desires of the user 204 (a corresponding fourth value of correlation will be calculated in the remote apparatus 203, indicating how well the second user 204 matches the desires of the first user 202). As above, the third value of correlation is compared to a third threshold value in the apparatus 201 (and the fourth value of correlation is compared to a fourth threshold value in the apparatus 203). If the third value of correlation meets or exceeds the third threshold value, it is ultimately determined, in the apparatus 201, that there is a match between users 202 and 204. This does not necessarily mean that the successful match is mutual, i.e. that both users are alerted, since the third and fourth threshold values can be chosen individually by the users 202 and 204. A successful match may be alerted to the user by a visual, audible or tactile indication through the user interface 314.

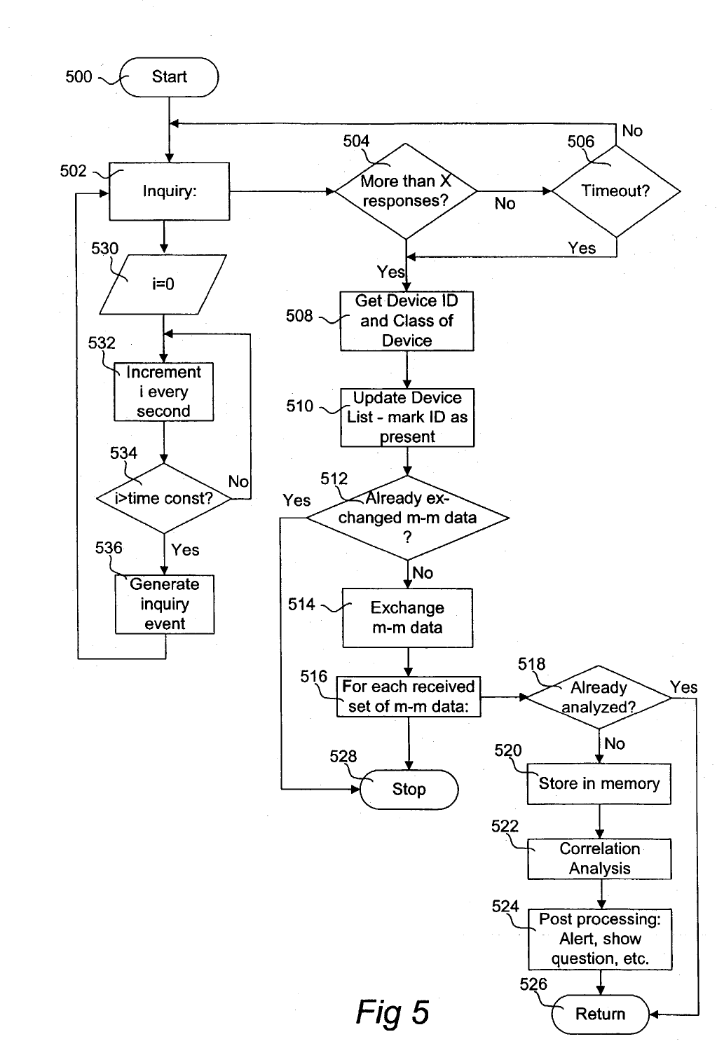

The correlation analysis described above is repeated for all sets of remote match-making data received from the remote apparatus. For instance, in the situation shown in FIG. 2e, the fourth apparatus 207 will perform correlation analysis not only on the match-making data 201′ associated with the first apparatus 201 but also on the match-making data 203′ and 205′ that is supplied by the first apparatus 201 together with its own match-making data 201. However, the match-making procedure according to one embodiment may be adapted to avoid repeated correlation analysis on remote match-making data which has already earlier been received and analyzed, as will be described in more detail with reference to step 520 of FIG. 5.

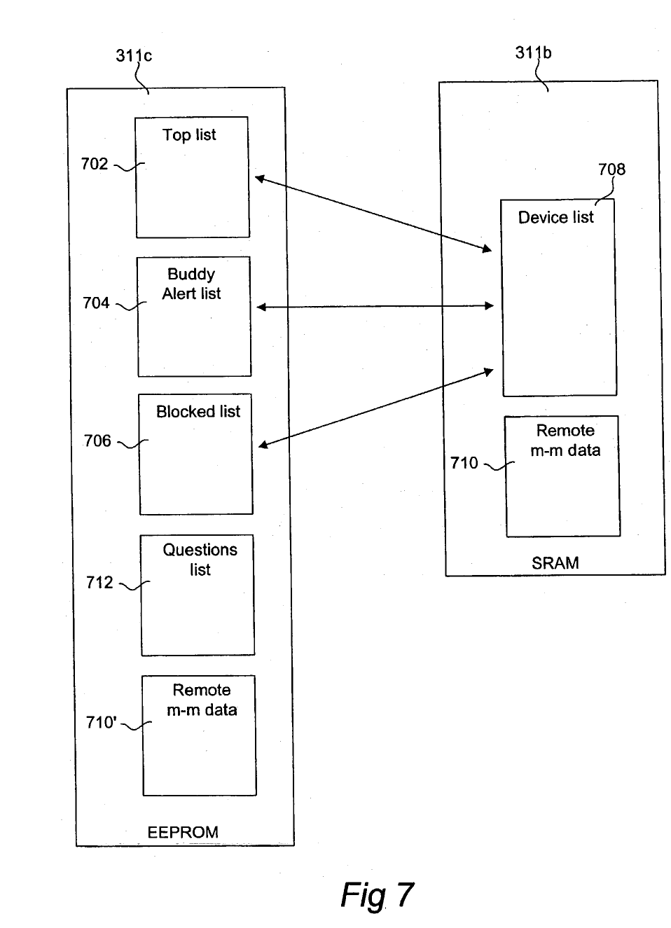

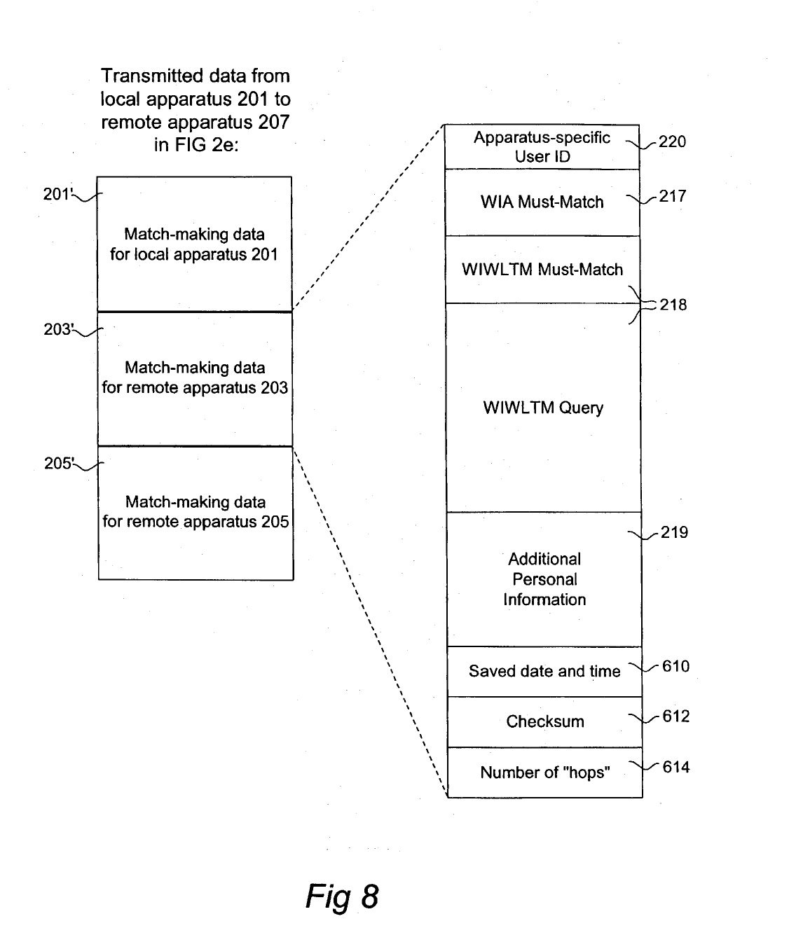

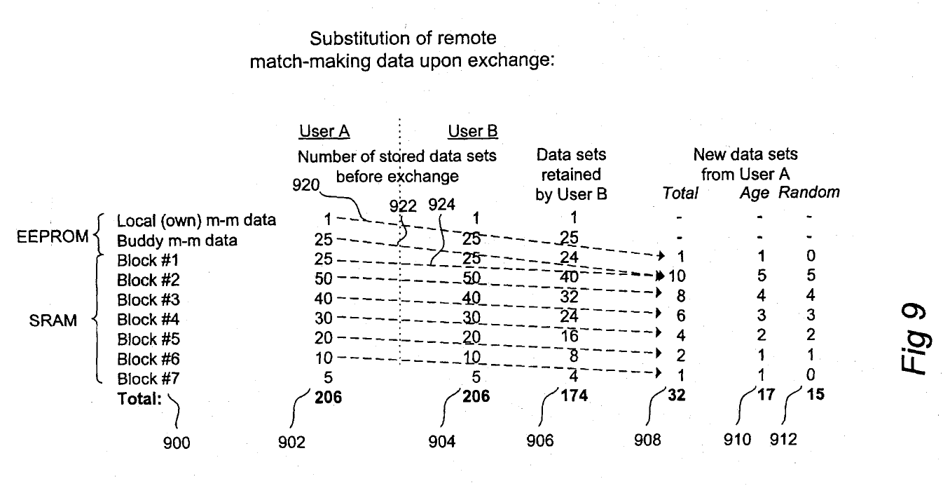

In one embodiment, the application software 402 has support for several lists, which are indicated in FIG. 7: A Top list 702, a Buddy Alert list 704, a Blocked list 706, a Device list 708 and a Questions list 712. The lists 702-706 are stored in non-volatile memory (EEPROM memory 311c), but the contents thereof are merged into the Device list 708 upon application initialization. The Device list 708 is temporarily stored in volatile work memory (SRAM memory 311b) for optimum performance, and the contents thereof is lost when the apparatus 201 is turned off. Therefore, during operation, any changes made to a record in the Device list 708 will automatically be written back to the appropriate permanent list 702, 704 or 706 by the application software 402. Thus, in a sense, the Device list 708 resembles a cache memory.

The Top list 702 is a high score list which stores the X best historical matches in the apparatus 201, so that the user 202 can access them at any time. X may for instance be 10, 50 or 100; the actual value will be chosen in view of an actual application and is not critical to the invention.

The Buddy Alert list 704 allows the user 202 to store links, in the form of apparatus-specific user-IDs, to other apparatuses 203, 205, 207 belonging to friends, family members, etc. A remote apparatus ID may be added onto the Buddy Alert list 704 either by copying that record from the Top list 702 or Device list 708, or by creating a record manually through the GUI.

Once an apparatus which is represented in the Buddy Alert list 704 comes within range and is detected through the inquiry management, the presence thereof will be alerted to the user 202 through the GUI. Moreover, in one embodiment, the user 202 may browse the Buddy Alert list 704 through the display 304 of the GUI, and each Buddy Alert list record may have a graphical indication which shows whether that apparatus is within range and, even, how close it is.

The Blocked list 706 allows the user 202 to prevent further communication from another apparatus 203, 205 or 207. This may be useful for stopping involuntary harassments, spam messages through the ask-questions functionality, etc. Thus, the present apparatus 201 will not reply to any Bluetooth communication from an apparatus which is represented in the Blocked list 1406. A remote apparatus may be added onto the Blocked list 706 either by copying that record from the Top list 702 or by creating a record manually through the GUI.

The Device list 708 is a general list for keeping track of available Bluetooth devices, including other portable communication apparatuses 203, 205, 207. This list will be used from several processes and tasks in the base software 404 and application software 402. For each remote apparatus present in the Device list 708, status data will be maintained to indicate whether the remote apparatus is in Buddy Alert list, is in Top list, is in Blocked list, has responded to inquiries, has been analyzed in terms of its match-making data (if so, including calculated value of correlation), etc.

In addition to the lists described above, a set 710 of previously received remote match-making data is stored in SRAM 311b to allow subsequent distribution to other apparatuses in the manner previously described. In one embodiment, the set 710 is also mirrored or saved back to non-volatile EEPROM memory 311c (reference numeral 710′ in FIG. 7) as a safeguard against power failures, application software failures, etc., at least when the apparatus is turned off but advantageously also at periodic intervals during operation.

In another embodiment, to prevent the memories 311b and 311c from becoming over-filled with remote match-making data 710, the remote match-making data 710 in SRAM 311b is not saved back to EEPROM memory 311c; therefore the remote match-making data 710 will be discarded from SRAM 311b every time the local apparatus 201 is turned off.

In yet another embodiment remote match-making data 710 for remote apparatuses is saved and accumulated in memory only until a successful match with any of the remote apparatuses has been determined by the local apparatus 201. Then, the remote match-making data 710 is discarded from SRAM 311b and EEPROM memory 311c.

Alternatively, SRAM 311b and EEPROM memory 311c may be configured to store a limited number of remote match-making data sets 710 on a first-in first-out basis.

In still another embodiment, only match-making data for remote apparatuses that are listed in the Buddy Alert list 704 is stored and accumulated as remote match-making data 710 in SRAM 311b and EEPROM memory 311c.

In an alternative embodiment, all exchanged match-making data 201′, 203′, 205′, 207′ includes a counter or other information which reflects the number of “hops” between intermediate apparatuses that the remote match-making data has undertaken on its way from the original apparatus to the current recipient. In this embodiment, the local apparatus 201 may be adapted to save and accumulate only such remote match-making data which has traveled a predetermined maximum number of “hops”.

In yet an alternative embodiment, all exchanged match-making data 201′, 203′, 205′, 207′ includes a universal time stamp, indicating a time of origin expressed in a time base which is common to all apparatuses. For instance, each apparatus may be provided with a real-time clock, or with a clock for Internet time. In this embodiment, the local apparatus 201 may be adapted to save and accumulate only such remote match-making data which is younger than a predetermined age.

In still an alternative embodiment, as seen in FIG. 9, the memory for storing remote match-making data is divided into different memory blocks 900, for instance 7 blocks, each block being adapted to store a respective maximum number of remote match-making data sets. Each block consists of remote match-making data sets that have traveled a corresponding number of “hops” from original apparatuses to current apparatus. More specifically, memory block #1 will contain remote match-making data sets that have traveled 1 “hop”, i.e., have been received directly from the original apparatuses. Using the example of FIG. 2c, match-making data set 203′ will be stored in memory block #1 in apparatus 201 upon exchange with apparatus 203. Memory block #2 will contain remote match-making data sets that have traveled 2 “hops”, i.e., have been received by the current apparatus from one intermediate apparatus, which in turn received such data sets from their original apparatuses. Generally, memory block #n will contain data sets that have passed (n−1) intermediate apparatus(es) from their original apparatuses to the current apparatus.

The memory blocks may have different sizes, particularly for allowing storage of more match-making data sets among those having fewer “hops” than among those having more “hops”. This design will provide a trade-off between the desire to retain some historic (old) remote match-making data and thereby allow such remote match-making data to spread as widely as possible, and the desire to make the handling and distribution of match-making data dynamic and receptive to more recent (new) match-making data.

Thus, it is preferred that each apparatus retain a rather large fraction of its currently stored remote match-making data and only substitute a minor fraction thereof with remote match-making data from the other apparatus. Otherwise, there would be a risk that the collection of remote match-making data would rapidly becomes homogeneous within a local environment or group of apparatuses. For instance, a maximum of 5-20% of the remote match-making data sets are replaced in the memory (20% is used in the example of FIG. 9). Deletion of match-making data that the memory can not keep due to memory restrictions may be handled in different ways, such as first-in-first-out, depending on timestamp of original transmission (“age method”), or even in a randomized way (“random method”). The percentage of the fraction of the remote match-making data which is substituted upon exchange with another apparatus may even be a function of exchange frequency or intensity. More specifically, the more frequent exchange of match-making data occurs, the lower is the percentage of the fraction that is substituted. The reason for this is that in an environment where there many portable communication apparatuses, match-making data will be exchanged frequently anyway, whereas in an environment where there are less apparatuses, a higher percentage is required so as to make the collection of remote match-making data more dynamic.

FIG. 9 gives an example of the above. As seen at 900, the memory block #1-#7 for remote match-making data may be stored in volatile memory, such as SRAM 311b of FIG. 3. The local (own) match-making data may be stored, together with the Buddy Alert list, in non-volatile memory, such as EEPROM 311c of FIG. 3. FIG. 9 illustrates one exemplifying way in which remote match-making data may be substituted upon exchange between two users, A and B, and their respective apparatuses. Prior to data exchange, it is assumed in FIG. 9 that the memories of both apparatuses are full. Thus, as seen at 902, User A has 25 remote match-making data sets stored in memory block #1, 50 in block #2, etc, in a total of 180 data sets in the memory blocks. In addition to this, 1 local match-making data set is stored, together with 25 match-making data sets on the Buddy Alert list, in the apparatus of User A. The apparatus of User B has corresponding numbers of data sets stored, as seen at 904.

Upon data exchange, the apparatus of User B retains 80% of the remote match-making data sets stored is the majority of its blocks (indicated at 906), whereas 20% are substituted by remote match-making data sets from User A, as seen at 908. For instance, of the 50 data sets that were stored in block #2 of User B, 40 are retained and 10 are substituted by data sets from block #1 of User A, as indicated by arrow 924, and from the Buddy Alert list of User A, as indicated by arrow 922. For these 10 data sets, 5 are selected by the aforesaid “age method” (see 910), and 5 are selected by the “random method” (see 912).

As indicated by arrow 920, the local match-making data of User A replaces one of the 25 data sets in block #1 of User B.

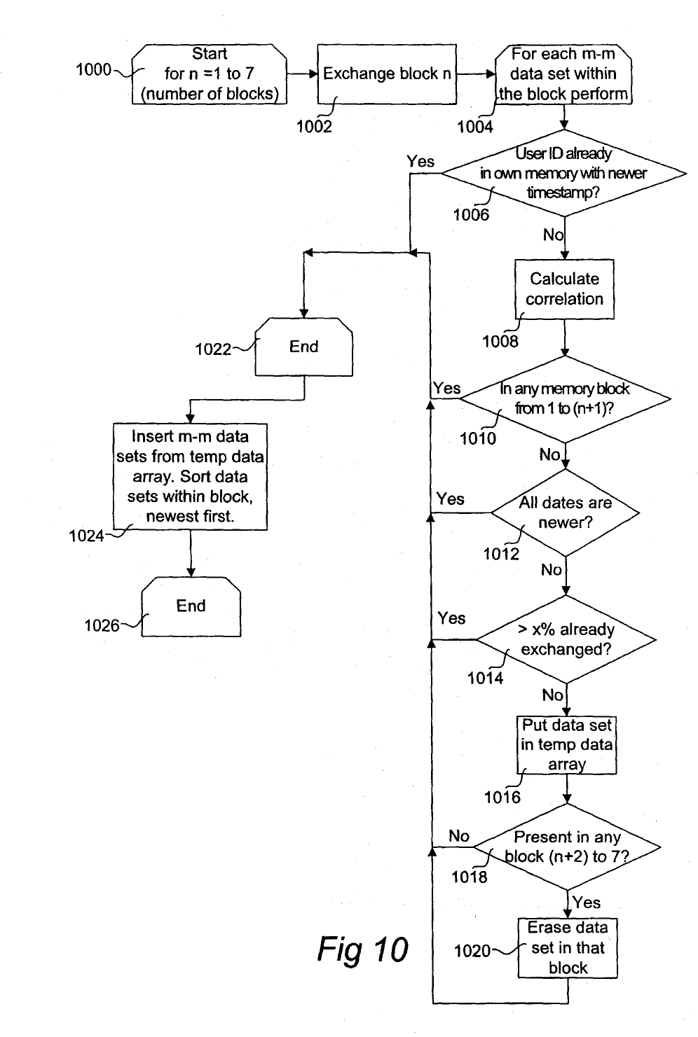

FIG. 10 illustrates a flow chart for the exchange of remote match-making data according to the embodiment described above. While most of this drawing is believed to be self-explanatory, it will only be briefly described in the following. As seen at 1000 and 1002, each memory block will be separately exchanged between the two apparatuses. Once a memory block has been received, the contents thereof, i.e. each individual match-making data set, will be processed in a number of steps 1004-1022. Then, the results of the processing, namely a selection of data sets that is to be included in the existing match-making data for each block, are inserted in the existing match-making data in step 1024.

Referring to the processing in steps 1004-1022, it is first checked in step 1006 whether a newer instance of the particular match-making data set already exists in the receiving apparatus. If not, correlation analysis is performed in step 1008. Following that, it is checked in step 1010 whether the data set already exists in a preceding block of the receiving apparatus, in step 1012 whether the data set is older than all existing data sets in the particular block of the receiving apparatus, and in step 1014 whether the predetermined fraction of match-making data has already been substituted. If the answer in any of steps 1010-1014 is affirmative, the particular data set will not be included in the existing match making data of the receiving apparatus. If, on the other hand, all answers are negative, the particular data set will be put in a temporary data array in step 1016, the contents of which will later be retrieved in step 1024 for insertion in the existing match-making data. In step 1018 it is checked whether the particular data set exists in any of the succeeding blocks; if so, the particular data set is erased from such a succeeding block—there is no need to let the particular data set occur in more than one memory block.

It is to be observed that in the exemplifying flow chart of FIG. 10, only aforesaid “age method” is applied (step 1012) but not the “random method”.

The contents of the Top list 702, Buddy Alert list 704 and Blocked list 706 can be accessed by the user through the GUI of the apparatus at any time. For instance, the user may select a certain user-friendly name in either the Top list 702 or the Buddy Alert list 704 and try to initiate a chat session by addressing the apparatus-specific user-ID associated with that user-friendly name.

The inquiry management performed by the application software 402 and base software 404 in one embodiment is illustrated in more detail in FIG. 5. Within the context of this invention, inquiry means repeatedly searching for remote apparatuses 203, 205, 207 that are within range of the local apparatus 201. Generally, the inquiry handling of this embodiment involves two modes: a scan mode in which the apparatus 201 will be responsive to inquiries from other apparatuses but will itself not make any inquiries, and an inquiry mode in which the present apparatus 201 will transmit inquiry messages in the form of radio signals through its Bluetooth interface. The frequency and duration of the scan mode in relation to the inquiry mode may be set by the user 202 or may be handled automatically by the apparatus 201 in an adaptive manner.

The inquiry mode may, e.g., last for a maximum period of 5 seconds every 30 seconds, but these values are not critical to the invention.

As seen in FIG. 5, after an initializing step 500, the inquiry mode 502 will be entered at a certain interval, as described above. In steps 530-536, inquiry events will be generated and intercepted by the base software 404, which in turn will form and transmit the actual inquiry messages through the radio module 309 and the antenna 310. Inquiry generation will continue until either a predetermined number of responses have been received, at 504, or a timeout occurs (after, e.g., 5 seconds), as seen at 506.

Then, for each responding remote apparatus 203, etc., the apparatus-specific user-ID 220 and also its class of device (apparatus type) will be determined in step 508. In steps 510 and 512, the Device list 708 is checked to see whether the responding apparatus is already represented in the list. If so, the responding apparatus is marked as present in the Device list 708, and if the Device list 708 indicates that match-making data has already been exchanged with this responding apparatus, the user 202 is alerted in case the user-ID of the responding apparatus 201 is indicated as Buddy in the Device list 708. Moreover, a check is made to see if the responding apparatus 203 is indicated as Blocked, wherein further communication will be prevented. Then, the execution proceeds to end at 528.

Otherwise, the present apparatus 201 tries to exchange match-making data with the responding remote apparatus in step 514. If this for some reason is not successful (perhaps because the responding apparatus has moved away from and out of range of the local apparatus 201), the execution is aborted.

If match-making data was successfully received from the responding apparatus by the local apparatus 201, the received data—including the WIA (Must-Match parameters only) and WIWLTM profiles of the responding apparatus as well as its attached additional personal information, plus apparatus-specific user ID, WIA and WIWLTM profiles as well as additional personal information for other remote apparatuses that the responding apparatus may previously have exchanged match-making data with—is processed in the following manner in a loop formed by steps 516-526.

First, it is checked in step 518 whether correlation analysis has already been performed, at a previous moment, on the particular set of remote match-making data. If so, the loop moves on to the next iteration, as indicated at 526, to check the next received set of match-making data, if any. Otherwise, the particular set of remote match-making data is stored in local memory at 520, as described above. Then, correlation analysis is performed in step 522 on the particular set of remote match-making data in the manner previously described. The calculated third value of correlation is checked against aforesaid threshold value to see if the remote apparatus associated with the analyzed set of match-making data qualifies as a match. If so, in step 524 the user of the local apparatus is duly alerted, using any of the standard ways of alerting, or alternatively by playing a personal ring signal 608, if available in the particular set of received match-making data. If the calculated third value of correlation qualifies for entry into the Top list 702, a record in the Device list 708 is marked accordingly. If a question was attached in the text field 706 of the received profile data, this question is displayed on the display 304. Then, the loop returns to a next iteration, if applicable, in step 526.

In one embodiment the apparatus can emit different types of alerts according to the user's choice. For example, the alert can be the user's favorite love song or some other audible signal which allows for two users to find each other directly by match, by simply tracking the sound. A more discrete type of alert is a visual one, such as an indication in the display or a flashing lamp on the apparatus. An even more discrete alert is a perceptible one, such as a vibration which can only be sensed by the user.

The apparatus according to the present invention may, for example, be realized as a separate, stand-alone unit, or may alternatively be included in, or combined with, a mobile terminal for a telecommunications network, such as GSM, UMTS, GPRS or D-AMPS, or another portable device of existing type, such as PDA or palmtop computer. In one embodiment, the present invention is embodied as application software in a mobile telephone. The mobile telephone may have a 32 bit multitasking operating system (OS), for example, as developed by Symbian Ltd., 19 Harcourt Street, London, W1H 4HF, UK (<www.symbian.com>). In this embodiment, the software structure of the mobile telephone is divided into sub layers: core application software, user interface, application engine, system layer and core operating system. A predefined application programming interface (API) is provided between the application software and the application engine. The application software includes various segments of program code, which when executed by the CPU will implement all the necessary functionality of the invention. The Symbian OS components provide data management, communications, graphics, multimedia, security, application engines, messaging engine, Bluetooth functionality, browser engines and support for data synchronization and internationalization, together with hardware-dependent functionality such as device drivers and memory handling. The mobile telephone may for instance be any one of the models 9200, 7650 or 3650 from Nokia, or P800 from Sony Ericsson.

The invention has mainly been described above with reference to a preferred embodiment. However, other embodiments than the one disclosed above are equally possible within the scope of the invention, as defined by the appended patent claims.

Of course, the different embodiments described herein may be combined in the sense that one apparatus according to one embodiment (e.g. a stand-alone apparatus as in FIGS. 1a-c) may exhange match-making data with another apparatus according to another embodiment (e.g. a mobile telephone having application software that implements the invention).

AII terms used in the claims are to be interpreted according to their ordinary meaning in the technical field, unless explicitly defined otherwise herein. All references to “a/an/the [element or step]” are to be interpreted openly as referring to at least one instance of said element or step.

What is claimed is:

1. A portable communication apparatus for match-making with a plurality of remote communication apparatuses, said portable communication apparatus comprising:
memory means, wherein said memory means is adapted to store match-making data, including local match-making data associated with said portable communication apparatus;
a transceiver, wherein said transceiver is adapted for wireless communication with a first remote communication apparatus, so as to transmit said local match-making data to said first remote communication apparatus, as well as to receive first remote match-making data associated with said first remote communication apparatus;
a processing device, wherein said processing device is adapted to perform a correlation analysis between said local match-making data and said first remote match-making data and—in case a result of said correlation analysis indicates a match between said portable communication apparatus and said first remote communication apparatus—provide an alert to a user of said portable communication apparatus;
wherein said memory means is adapted to store said first remote match-making data; and
wherein said transceiver is adapted to transmit said first remote match-making data, in addition to said local match-making data, to a second remote communication apparatus.

2. An apparatus as in claim 1, wherein said transceiver is adapted to receive also third remote match-making data associated with a third remote communication apparatus from said first remote communication apparatus; and
wherein said processing device is adapted to perform a correlation analysis between said local match-making data and said third remote match-making data and—in case a result of said correlation analysis indicates a match between said portable communication apparatus and said third remote communication apparatus—provide an alert to said user of said portable communication apparatus.

3. An apparatus as in claim 2, wherein said processing device is adapted to first check whether correlation analysis has already been performed for said first and said third remote match-making data, respectively, and, if so, refrain from performing the correlation analysis for said first and said third remote match-making data, respectively.

4. An apparatus as in claim 2, said memory means including volatile memory and non-volatile memory, wherein said first and said third remote match-making data are stored in said volatile memory upon reception from said first remote communication apparatus and are stored in said non-volatile memory at least either periodically or at power-off of said portable communication apparatus.

5. An apparatus as in claim 2, wherein said memory means is further adapted to discard said first and said third remote match-making data, once said processing device has indicated a match.

6. An apparatus as in claim 2, wherein said memory means is adapted to store a predetermined maximum amount of remote match-making data on a first-in first-out basis.

7. An apparatus as in claim 2, said first and said third remote match-making data each including travel information pertaining to a number of steps of transmission between individual ones of said plurality of remote communication apparatuses from an original remote communication apparatus to said first and third remote communication apparatus, respectively, wherein said memory means is adapted to store said first and said third remote match-making data, respectively, only if its travel information is less than a predetermined limit.

8. An apparatus as in claim 2, said first and said third remote match-making data each including a time stamp, expressed in a common time base and indicating a time of origin, wherein said memory means is adapted to store said first and said third remote match-making data, respectively, only if its time stamp indicates an age which is below a predetermined limit.

9. An apparatus as in claim 2, wherein said first or said third remote match-making data includes contact information enabling said user of said portable communication apparatus to contact a user of said first or third remote communication apparatus through communication means other than said portable communication apparatus.

10. An apparatus as in claim 9, wherein said contact information includes at least either an email address or a telephone number.

11. An apparatus as in claim 1, wherein each of said match-making data is associated with a respective apparatus-specific identity which is unique among said portable communication apparatus and each of said plurality of remote communication apparatuses.

12. An apparatus as in claim 1, being embodied in or as a mobile terminal for a telecommunications network.

13. An apparatus as in claim 12, wherein said mobile terminal comprises an operating system and application software, said application software being adapted to be executed by said processing device and cause said processing device to perform aforesaid correlation analysis.

14. An apparatus as in claim 13, wherein said operating system is a Symbian operating system.

15. An apparatus as in claim 1, being embodied in or as a Portable Digital Assistant or a palmtop computer.

16. An apparatus as in claim 1, wherein said transceiver is adapted to communicate in accordance with the Bluetooth specification.

17. An apparatus as in claim 1, wherein said memory means is adapted to store prioritized match-making data of a limited number of users of remote communication apparatuses in non-volatile memory and wherein said transceiver is adapted to transmit all of this prioritized match-making data when communicating with a remote communication apparatus.

18. An apparatus as in claim 1, wherein said memory means comprises a predetermined number of memory blocks, each memory block being adapted to store remote match-making data that has traveled a respective number of steps of transmission between individual ones of said plurality of remote communication apparatuses from an original remote communication apparatus to said portable communication apparatus.

19. An apparatus as in claim 18, wherein said memory means comprises 7 memory blocks.

20. An apparatus as in claim 18, wherein one of said memory blocks is adapted to store a larger amount of remote match-making data than another one of said memory blocks, said another one of said memory blocks being adapted to store remote match-making data having traveled more steps of transmission than remote match-making data that said one of said memory blocks is adapted to store.

21. A method for match-making between a portable communication apparatus and a plurality of remote communication apparatuses, the method comprising the steps of:
storing, in local memory in said portable communication apparatus, local match-making data associated with said portable communication apparatus;
establishing a first wireless link to a first remote communication apparatus;
transmitting said local match-making data to said first remote communication apparatus;
receiving, from said first remote communication apparatus, first remote match-making data associated with said first remote communication apparatus;
performing a correlation analysis between said local match-making data and said first remote match-making data;
determining whether a result of said correlation analysis indicates a match between said portable communication apparatus and said first remote communication apparatus;
if so, providing an alert to a user of said portable communication apparatus;
storing said first remote match-making data in local memory in said portable communication apparatus;
establishing a second wireless link to a second remote communication apparatus; and
transmitting said first remote match-making data, in addition to said local match-making data, to said second remote communication apparatus.

22. A method as in claim 21, wherein said step of receiving from said first remote communication apparatus includes receiving also third remote match-making data associated with a third remote communication apparatus from said first remote communication apparatus; and
wherein said step of performing a correlation analysis includes performing a correlation analysis between said local match-making data and said third remote match-making data.

23. A method as in claim 22, comprising the additional step of checking whether correlation analysis has already been performed for said first and said third remote match-making data, respectively, and, if so, refrain from performing the correlation analysis for said first and said third remote match-making data, respectively.

24. A method as in claim 22, comprising the additional steps of
storing said first and said third remote match-making data in volatile memory upon reception from said first remote communication apparatus; and
storing said first and said third remote match-making data in non-volatile memory at least either periodically or at power-off of said portable communication apparatus.

25. A method as in claim 22, comprising the additional step of discarding said first and said third remote match-making data, once a match has been determined between said local match-making data and any remote match-making data.

26. A method as in claim 22, comprising the additional step of storing a predetermined maximum amount of remote match-making data on a first-in first-out basis in said local memory.

27. A method as in claim 22, wherein said first and said third remote match-making data each includes travel information pertaining to a number of steps of transmission between individual ones of said plurality of remote communication apparatuses from an original remote communication apparatus to said first and third remote communication apparatus, respectively, the method comprising the step of storing said first and said third remote match-making data, respectively, only if its travel information is less than a predetermined limit.

28. A method as in claim 22, wherein said first and said third remote match-making data each includes a time stamp, expressed in a common time base and indicating a time of origin, the method comprising the step of storing said first and said third remote match-making data, respectively, only if its time stamp indicates an age which is below a predetermined limit.

29. A method as in claim 22, wherein said first and said third remote match-making data each includes travel information pertaining to a number of steps of transmission between individual ones of said plurality of remote communication apparatuses from an original remote communication apparatus to said first and third remote communication apparatus, respectively, and wherein said local memory comprises a predetermined number of memory blocks, the method comprising the step of storing said first and said third remote match-making data, respectively, in a memory block that has a predetermined relation to said number of steps of transmission, as indicated by said travel information.

30. A method of exchanging match-making data between a portable communication apparatus and a remote communication apparatus over a wireless link, the method comprising the steps, performed in said portable communication apparatus, of
receiving a plurality of remote match-making data sets from said remote communication apparatus; and
deciding to store one of said plurality of remote match-making data sets depending on at least one of the following criteria:
i) an age or time of origin of said one data set;
ii) travel information pertaining to a number of steps of transmission for said one data set from an original remote communication apparatus to said remote communication apparatus;
iii) a fraction or an amount of remote match-making data sets that have already been stored prior to said one data set;
iv) a random value.

31. A method as in claim 30, wherein remote match-making data sets are stored in said portable communication apparatus in local memory having a predetermined number of memory blocks, each memory block representing a number of steps of transmission for a data set from an original remote communication apparatus to said portable communication apparatus, and wherein the decision to store said one of said plurality of remote match-making data sets is limited to one of said memory blocks, which according to said travel information has a predetermined relation to said one data set.

32. A method as in claim 30, wherein the fraction or amount in criterion iii) is a function of the intensity or frequency of prior data exchange between the portable communication apparatus and other remote communication apparatuses.
